(19) United States
(12) Patent Application Publication
(10) Pub. No.: US 2023/0353222 A1
(43) Pub. Date: Nov. 2, 2023

(54) METHOD FOR BEAM SEARCH AND MANAGEMENT OF MOVING BACKHAUL SYSTEM, AND MOVING BACKHAUL HUB USING THE SAME

(71) Applicant: ELECTRONICS AND TELECOMMUNICATIONS RESEARCH INSTITUTE, Daejeon (KR)

(72) Inventor: Kyung Yeol SOHN, Daejeon (KR)

(73) Assignee: ELECTRONICS AND TELECOMMUNICATIONS RESEARCH INSTITUTE, Daejeon (KR)

(21) Appl. No.: 18/304,920

(22) Filed: Apr. 21, 2023

(30) Foreign Application Priority Data
Apr. 28, 2022 (KR) 10-2022-0052982

(51) Int. Cl. H04B 7/06

(52) U.S. Cl. CPC H04B 7/06952; H04W 84/005

(57) ABSTRACT

A beam management method performed by a moving backhaul hub may comprise: calculating, based on location information at a first time, a first separation distance between the moving backhaul hub and a moving backhaul terminal, a first azimuth angle to which a beam of the moving backhaul hub is directed, and a first elevation angle in which the beam of the moving backhaul hub is directed; determining an operation mode of the moving backhaul terminal using the first separation distance, the first azimuth angle, and/or the first elevation angle; determining whether to transmit a beam search command message to the moving backhaul terminal based on the operation mode of the moving backhaul terminal; and transmitting signals to the moving backhaul terminal in consideration of the operation mode when the beam search command message is transmitted to the moving backhaul terminal.

### CROSS-REFERENCE TO RELATED APPLICATIONS

This application claims priority to Korean Patent Application No. 10-2022-0052982, filed on Apr. 28, 2022, with the Korean Intellectual Property Office (KIPO), the entire contents of which are hereby incorporated by reference.

### BACKGROUND

### 1. Technical Field

Exemplary embodiments of the present disclosure relate to a method for beam search and beam management, and more particularly, to a method for searching and managing beams in a moving backhaul system.

### 2. Related Art

Recently, due to the rapid development of industrial technology and information communication technology, development of technologies is being actively carried out with a goal of providing a basic service with enhanced Moving Broadband (eMBB) communication,

Ultra-Reliable & Low-Latency Communication (URLLC), and massive Machine-Type Communication (mMTC). In particular, a small cell technology is attracting attention as a technology capable of coping with rapidly increasing moving traffic, satisfying Quality of Service (QoS) required by moving communication service users, and increasing a channel capacity per unit area of a base station.

Accordingly, wireless backhaul technology that enables high-speed and high-reliability broadband transmission based on a millimeter wave band is being developed. The wireless backhaul technology can be widely applied to a moving wireless backhaul technology utilizing various moving entities such as vehicles, trains, and drones. In particular, a millimeter wave moving wireless backhaul technology can be widely applied to various fields such as transportation services, relay broadcasting, emergency relief goods supply, safety accident monitoring, and pesticide spraying.

Meanwhile, the millimeter wave band-based wireless backhaul technology may have a large path loss due to characteristics of a millimeter wave frequency having a short wavelength, and thus there may be restrictions on long-distance communication. In addition, due to a mobility provided by the moving backhaul system, there may occur a problem in which a line of sight (LOS) between a backhaul transmitter and a backhaul receiver is not secured, and thus a backhaul link may be interrupted.

### SUMMARY

Exemplary embodiments of the present disclosure are directed to providing a method for searching and/or managing beams in a moving backhaul system.

According to a first exemplary embodiment of the present disclosure, a beam management method, performed by a moving backhaul hub in a moving backhaul system, may comprise: calculating, based on location information at a first time, a first separation distance between the moving backhaul hub and a moving backhaul terminal, a first azimuth angle to which a beam of the moving backhaul hub is directed, and a first elevation angle in which the beam of the moving backhaul hub is directed; determining an operation mode of the moving backhaul terminal using the first separation distance, the first azimuth angle, and/or the first elevation angle; determining whether to transmit a beam search command message to the moving backhaul terminal based on the operation mode of the moving backhaul terminal; and transmitting signals to the moving backhaul terminal in consideration of the operation mode when the beam search command message is transmitted to the moving backhaul terminal.

The determining of the operation mode may comprise: calculating a second separation distance between the moving backhaul hub and the moving backhaul terminal based on location information at a second time; and determining the operation mode of the moving backhaul terminal as a moving mode when a difference between the first separation distance and the second separation distance is equal to or greater than a first predetermined value.

The determining of the operation mode may comprise: calculating a second azimuth angle to which the beam of the moving backhaul hub is directed based on location information at a second time; and determining the operation mode of the moving backhaul terminal as a moving mode when a difference between the first azimuth angle and the second azimuth angle is equal to or greater than a second predetermined value.

The determining of the operation mode may comprise: calculating a second elevation angle to which the beam of the moving backhaul hub is directed based on location information at a second time; and determining the operation mode of the moving backhaul terminal as a moving mode when a difference between the first elevation angle and the second elevation angle is equal to or greater than a third predetermined value.

The determining of the operation mode may comprise: calculating, based on location information at a second time, a second separation distance between the moving backhaul hub and the moving backhaul terminal, a second azimuth angle to which the beam of the moving backhaul hub is directed, and a second elevation angle to which the beam of the moving backhaul hub is directed; and determining the operation mode of the moving backhaul terminal as a hovering mode when a difference between the first separation distance and the second separation distance is less than a first predetermined value, a difference between the first azimuth angle and the second azimuth angle is less than a second predetermined value, and a difference between the first elevation angle and the second elevation angle is less than a third predetermined value.

In the determining of whether to transmit the beam search command message, when the operation mode of the moving backhaul terminal is determined as a moving mode and a difference of instantaneous values of the first separation distance between the moving backhaul hub and the moving backhaul terminal is equal to or greater than a first predetermined value, the moving backhaul hub may determine to transmit the beam search command message to the moving backhaul terminal.

In the determining of whether to transmit the beam search command message, when the operation mode of the moving backhaul terminal is determined as a moving mode and a difference of instantaneous values of the first azimuth angle is equal to or greater than a second predetermined value, the moving backhaul hub may determine to transmit the beam search command message to the moving backhaul terminal.

In the determining of whether to transmit the beam search command message, when the operation mode of the moving backhaul terminal is determined as a moving mode and a difference of instantaneous values of the first elevation angle is equal to or greater than a third predetermined value, the moving backhaul hub may determine to transmit the beam search command message to the moving backhaul terminal.

In the determining of whether to transmit the beam search command message, when the operation mode of the moving backhaul terminal is determined as a hovering mode and a cumulative value of the first separation distance between the moving backhaul hub and the moving backhaul terminal is equal to or greater than a first predetermined value, the moving backhaul hub may determine to transmit the beam search command message to the moving backhaul terminal.

In the determining of whether to transmit the beam search command message, when the operation mode of the moving backhaul terminal is determined as a hovering mode and a cumulative value of the first azimuth angle is equal to or greater than a second predetermined value, the moving backhaul hub may determine to transmit the beam search command message to the moving backhaul terminal.

In the determining of whether to transmit the beam search command message, when the operation mode of the moving backhaul terminal is determined as a hovering mode and a cumulative value of the first elevation angle is equal to or greater than a third predetermined value, the moving backhaul hub may determine to transmit the beam search command message to the moving backhaul terminal.

The beam management method may further comprise: receiving, from the moving backhaul terminal, a beam search result message including measurement result information on the signals; and selecting a first beam having a largest signal strength based on the measurement result information of the signals.

According to a second exemplary embodiment of the present disclosure, a moving backhaul hub in a moving backhaul system may comprise: a processor; a memory electronically communicating with the processor; and instructions stored in the memory, wherein when executed by the processor, the instructions may cause the moving backhaul hub to perform: calculating, based on location information at a first time, a first separation distance between the moving backhaul hub and a moving backhaul terminal, a first azimuth angle to which a beam of the moving backhaul hub is directed, and a first elevation angle in which the beam of the moving backhaul hub is directed; determining an operation mode of the moving backhaul terminal using the first separation distance, the first azimuth angle, and/or the first elevation angle; determining whether to transmit a beam search command message to the moving backhaul terminal based on the operation mode of the moving backhaul terminal; and transmitting signals to the moving backhaul terminal in consideration of the operation mode when the beam search command message is transmitted to the moving backhaul terminal.

In the determining of the operation mode, the instructions may further cause the moving backhaul hub to perform: calculating a second separation distance between the moving backhaul hub and the moving backhaul terminal based on location information at a second time; and determining the operation mode of the moving backhaul terminal as a moving mode when a difference between the first separation distance and the second separation distance is equal to or greater than a first predetermined value.

In the determining of the operation mode, the instructions may further cause the moving backhaul hub to perform: calculating a second azimuth angle to which the beam of the moving backhaul hub is directed based on location information at a second time; and determining the operation mode of the moving backhaul terminal as a moving mode when a difference between the first azimuth angle and the second azimuth angle is equal to or greater than a second predetermined value.

In the determining of the operation mode, the instructions may further cause the moving backhaul hub to perform: calculating a second elevation angle to which the beam of the moving backhaul hub is directed based on location information at a second time; and determining the operation mode of the moving backhaul terminal as a moving mode when a difference between the first elevation angle and the second elevation angle is equal to or greater than a third predetermined value.

According to the present disclosure, a moving backhaul hub can determine an operation mode of a moving backhaul terminal, according to variation of a separation distance between the moving backhaul hub and the moving backhaul terminal and an azimuth angle and/or elevation angle in which a beam transmitted and received by the moving backhaul hub should be directed, which are calculated by utilizing location information.

In addition, according to the present disclosure, the moving backhaul hub can perform search and management of beams transmitted to the moving backhaul terminal using a preconfigured beam search method according to the operation mode of the moving backhaul terminal, thereby seamlessly maintaining a backhaul link.

### BRIEF DESCRIPTION OF DRAWINGS

FIG. 1 is a conceptual diagram illustrating a first exemplary embodiment of a system including a moving backhaul network.

FIG. 2 is a block diagram illustrating an exemplary embodiment of a communication node constituting a communication system.

FIG. 3 is a conceptual diagram illustrating a first exemplary embodiment of beam-widths used in a backhaul link according to a separation distance between a moving backhaul hub and a moving backhaul terminal.

FIG. 4 is a sequence chart illustrating a first exemplary embodiment of a beam search method of a moving backhaul system.

FIG. 5 is a flowchart illustrating a first exemplary embodiment of a procedure for determining an operation mode (hovering mode or moving mode) of a moving backhaul terminal performed in a moving backhaul hub.

FIG. 6 is a conceptual diagram illustrating a first exemplary embodiment of a beam search method of a moving backhaul system when a moving backhaul terminal is in a moving mode (a case of change in separation distance).

FIG. 7 is a conceptual diagram illustrating a first exemplary embodiment of a beam search method of a moving backhaul system when a moving backhaul terminal is in a moving mode (a case of change in azimuth angle).

FIG. 8 is a conceptual diagram illustrating a first exemplary embodiment of a beam search method of a moving backhaul system when a moving backhaul terminal is in a moving mode (a case of change in elevation angle).

FIG. 9 is a conceptual diagram illustrating a first exemplary embodiment of a beam search method of a moving backhaul system when a moving backhaul terminal is in a moving mode (a case of change in separation distance, azimuth angle, and elevation angle).

FIG. 10 is a conceptual diagram illustrating a second exemplary embodiment of a beam search method of a moving backhaul system when a moving backhaul terminal is in a moving mode (a case of change in separation distance, azimuth angle, and elevation angle).

FIG. 11 is a conceptual diagram illustrating a first exemplary embodiment of a beam search method of a moving backhaul system when a moving backhaul terminal is in a hovering mode.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may be used in the same sense as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSDPA), 4G mobile communication network such as a long term evolution (LTE) network or an LTE-Advanced network, 5G mobile communication network, beyond 5G (B5G) mobile communication network (e.g., 6G mobile communication network), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

With the development of information and communication technologies, various wireless communication technologies are being developed. As the representative wireless communication technologies, there may be long term evolution (LTE), new radio (NR), or the like defined as the 3rd generation partnership project (3GPP) specifications. The LTE may be one of 4th generation (4G) wireless communication technologies, and the NR may be one of 5th generation (5G) wireless communication technologies.

The 5G communication system (e.g., NR communication system) that can use a high frequency band (e.g., frequency band of 6 GHz or above) as well as a frequency band (e.g., frequency band of 6 GH or below) of the 4G communication system is being considered to process the soaring wireless data after commercialization of the 4G communication system (e.g., LTE communication system).

Due to the rapid development of industrial technology and information and communication technology, active technology development is being carried out to provide mobile communication services supporting enhanced mobile broadband (eMBB) service, ultra-reliable and low-latency communication (URLLC), and massive machine-type communication (mMTC) utilizing an ultra-wideband.

In the mobile communication system such as 5G or NR, it may be necessary to use a high frequency band such as a millimeter wave (mmWave) in order to satisfy the requirements of the communication system standards. In a high frequency band such as a millimeter wave, characteristics such as higher signal attenuation, high path loss, low diffraction, and strong straightness may appear than in a low frequency band. Accordingly, it may be necessary to deploy dense base stations in a communication environment to ensure smooth communications in such a high frequency band.

A small cell is a radio access base station with a low power output, and refers to a base station having an operating range of several tens to hundreds of meters (m) rather than an area of several kilometers (km). The above-described small cell technology is attracting attention as a technology capable of coping with rapidly increasing mobile traffic, satisfying QoS required by users of mobile communication services, and increasing channel capacity per unit area of a base station.

In addition, a wireless backhaul technology that forms a backhaul link between a hub and a terminal is attracting attention. In particular, a mmWave backhaul link based on the mmWave band can construct a mobile communication network capable of high-speed and high-reliability broadband transmission using radio waves with a wavelength of millimeters.

The above-described wireless backhaul technology has an advantage in that it can build a moving wireless backhaul network using various moving objects, such as terminals, cars, subways, trains, and/or drones whose positions are not fixed. The above-described moving wireless backhaul network may provide mobile communication services to terminals, cars, subways, and/or trains moving at a high speed using a Mobile Hotspot Network (MHN) technology. In particular, the moving wireless backhaul technology using aerial vehicles such as drones can be widely used in various fields by utilizing the characteristics of the aerial vehicles.

For example, the mobile communication service that supports the moving wireless backhaul technology using aerial vehicles can provide efficient and rapid transportation services such as courier service, and can provide relay broadcasting services using unmanned aerial vehicles. A disaster relief service that procures medical supplies or emergency relief supplies can be provided even in a disaster area that has not been restored, a safety management service can be provided for monitoring safety accidents at beaches or construction sites, and a control drone service can be provided for quickly spraying pesticides on an agricultural land having a large area.

The moving wireless backhaul technology using aerial vehicles may not have many geographical restrictions, and may have low installation costs or low maintenance and repair costs. In addition, the above-described moving wireless backhaul technology can quickly adapt to changes in the network environment by using mobility of the aerial vehicles. Accordingly, the moving wireless backhaul technology using aerial vehicles may have high commercial use value, and it may be required to provide a dedicated backhaul link for supporting large-capacity applications.

Meanwhile, a millimeter wave may have a large path loss due to atmospheric attenuation due to the characteristics of Extremely High Frequency (EHF), and may be greatly affected by rain attenuation due to scattering of raindrops. In addition, since a radio signal of the above-described ultra-high frequency band has a very high straightness, it may be used only in a Line of Sight (LOS) environment where there are no obstacles between a moving backhaul hub and a moving backhaul terminal. In addition, due to the mobility provided by the moving backhaul system, there may occur a problem in which a LOS between the moving backhaul hub and the moving backhaul terminal is not secured, and thus a backhaul link may be interrupted.

In this reason, a beam search and management technique capable of minimizing a transmission loss of a transmission/reception signal between the moving backhaul hub and the moving backhaul terminal may be required, in consideration of propagation environment characteristics such as high path loss and atmospheric attenuation of the millimeter wave band in proportion to a distance between the moving backhaul hub and the moving backhaul terminal.

Hereinafter, preferred exemplary embodiments of the present disclosure will be described in detail with reference to the accompanying drawings. In order to facilitate overall understanding in describing the exemplary embodiments of the present disclosure, the same reference numerals will be used for the same components in the drawings, and redundant descriptions of the same components will be omitted.

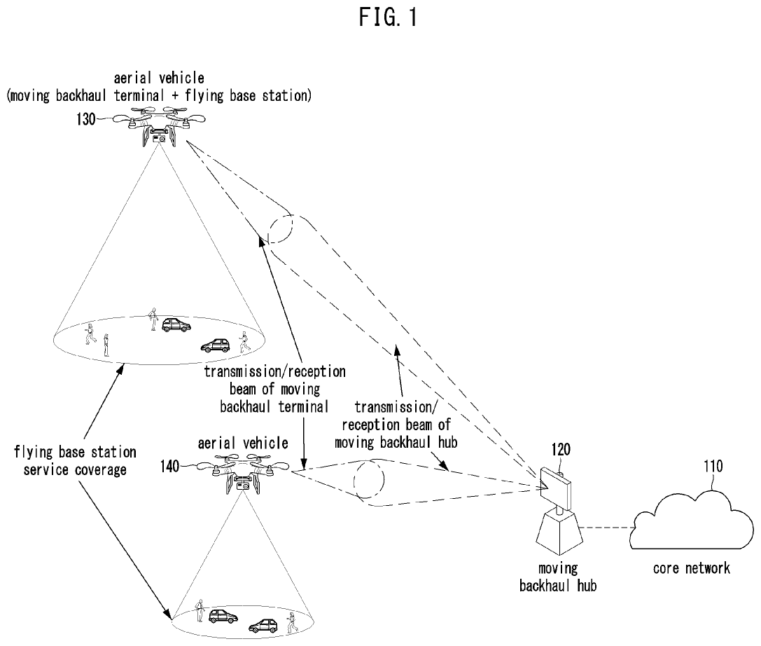

FIG. 1 is a conceptual diagram illustrating a first exemplary embodiment of a system including a moving backhaul network.

Referring to FIG. 1, a communication system including a moving backhaul network may comprise a core network 110, a moving backhaul hub 120, and/or at least one aerial vehicle 130 or 140.

When the moving backhaul system supports 4G communication, the core network 110 may include a Mobility Management Entity (MME), a Serving Gateway (S-GW), and a Packet Data Network Gateway (P-GW) and the like. When the moving backhaul system supports 5G communication, the core network may include an AMF, UPF, P-GW, and the like.

The moving backhaul hub 120 may be connected to the core network 110 and may be connected to a moving backhaul terminal mounted on at least one of the aerial vehicles 130 and 140. The at least one aerial vehicle 130 or 140 may be dispatched to an area where there are no or insufficient mobile communication infrastructures and stay above the area requiring services. The moving backhaul hub 120 may be used to aggregate backhaul traffics of the moving backhaul terminals mounted on the aerial vehicles 130 and 140. The moving backhaul terminal may allow a flying base station mounted on at least one of the aerial vehicles 130 and 140 to communicate with the core network 110 via the moving backhaul hub 120. A transceiver of the moving backhaul hub 120 may electronically form a beam and adjust or change a direction of the beam. A backhaul link may be formed between the moving backhaul hub 120 and the moving backhaul terminal. The backhaul link may require a wide transmission bandwidth to transmit large-capacity data serviced by the flying base station mounted on at least one of the aerial vehicles 130 and 140 to the core network 110. The moving backhaul system may perform long-distance communication by applying a beamforming technology in which the moving backhaul terminal located away from the moving backhaul hub changes a beam-width depending on a location. In addition, the moving backhaul system can configure a backhaul link in a place where vehicles and/or people cannot enter by using location information, and the moving backhaul system can utilize the aerial vehicles to replace communication infrastructures in wide disaster areas such as forest fires or floods.

The moving backhaul hub 120 may include at least one array antenna for forming a beam toward at least one of the aerial vehicles 130 and 140 to perform communication. The moving backhaul hub may use various methods and devices for beamforming (e.g., massive Multiple Input Multiple Output (MIMO), full dimensional MIMO (FD-MIMO), array antenna, analog beamforming, and a large scale antenna, and/or the like).

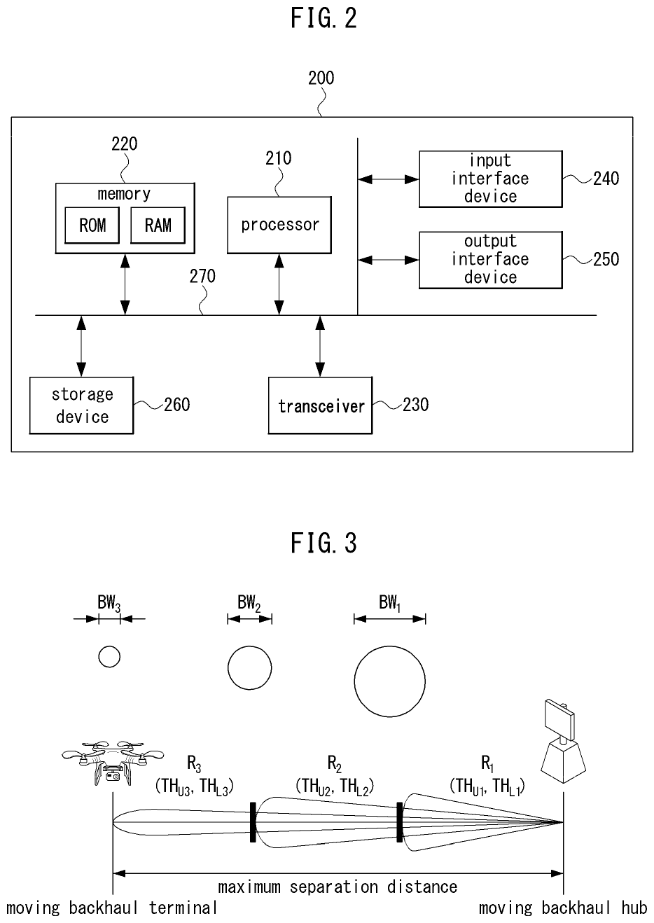

The above-described at least one aerial vehicle 130 or 140 may be equipped with a moving backhaul terminal and/or a flying base station. The above-described moving backhaul terminal can communicate with the moving backhaul hub 110 by forming a backhaul link with the moving backhaul hub 110, and the above-described flying base station can form an access link with at least one terminal to provide mobile communication services to the at least one terminal. A transceiver of the at least one of aerial vehicles 130 and 140 may electronically form a beam and adjust or change a direction of the beam. The at least one aerial vehicle may include at least one array antenna for forming a beam toward the moving backhaul hub 120 and/or at least one terminal. The moving backhaul terminal mounted on the at least one aerial vehicle may include a light-weight and directional horn-type antenna within a range that does not significantly affect a flight time. The communication nodes constituting the communication system including the moving backhaul network may be configured identically or similarly to a communication node 200 shown in FIG. 2 below.

Each of the at least one terminal may be referred to as a user equipment (UE), terminal, access terminal, mobile terminal, station, subscriber station, mobile station, portable subscriber station, node, device, Internet of Thing (IoT) device, mounted device (mounted module/device/terminal or on board device/terminal, etc.), and/or the like.

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Hereinafter, operation methods of a communication node in a communication system will be described. Even when a method (e.g., transmission or reception of a signal) performed at a first communication node among communication nodes is described, the corresponding second communication node may perform a method (e.g., reception or transmission of the signal) corresponding to the method performed at the first communication node. That is, when an operation of a terminal is described, the corresponding base station may perform an operation corresponding to the operation of the terminal. Conversely, when an operation of the base station is described, the corresponding terminal may perform an operation corresponding to the operation of the base station.

FIG. 3 is a conceptual diagram illustrating a first exemplary embodiment of beam-widths used in a backhaul link according to a separation distance between a moving backhaul hub and a moving backhaul terminal.

Referring to FIG. 3, a beam-width used for configuring a radio link of the moving backhaul system may be determined based on a separation distance d between the moving backhaul hub and the moving backhaul terminal. That is, the moving backhaul hub may use a beam having a narrow beam-width BW₃ for long-distance communication when the moving backhaul hub and the moving backhaul terminal are far apart. Alternatively, the moving backhaul hub may use a beam having the widest beam-width BW₁ when the moving backhaul hub and the moving backhaul terminal are in close proximity.

In addition, the moving backhaul system may determine a maximum separation distance dₘₐₓ at which the moving backhaul hub can provide mobile communication services to the moving backhaul terminal for efficient or stable communication. The moving backhaul system may determine beam regions R₁, R₂, and R₃, which are regions in which beams for configuring the radio link are respectively formed, based on the above-described maximum separation distance. The moving backhaul system may determine a beam-width BW₁, BW₂, or BW₃ used for configuring a backhaul link according to each beam region. The moving backhaul system may configure upper threshold values and/or lower threshold values ((TH_{U1}, TH_{L1}), (TH_{U2}, TH_{L2}), (TH_{U3}, TH_{L3})) which are threshold ranges of signal strengths for the respective beam regions R₁, R₂, and R₃.

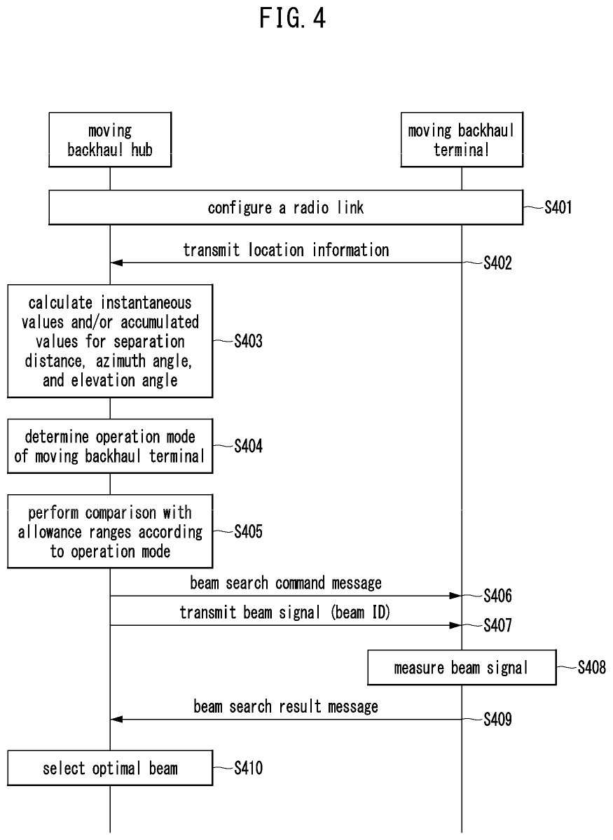

FIG. 4 is a sequence chart illustrating a first exemplary embodiment of a beam search method of a moving backhaul system.

Referring to FIG. 4, the moving backhaul hub may configure a radio link (hereinafter referred to as ‘backhaul link’) with the moving backhaul terminal (S401). The backhaul link may be configured between the moving backhaul hub and the moving backhaul terminal. After the backhaul link between the moving backhaul hub and the moving backhaul terminal is configured, the moving backhaul terminal may transmit location information of the moving backhaul terminal to the moving backhaul hub at a preset time interval (e.g., t₁, t₂, . . . , tₙ, tₙ₊₁, . . . ) (S402). The above-described location information may be Global Positioning System (GPS) information, and the above-described location information may include a latitude φ, longitude λ, and/or altitude h of the moving backhaul terminal. In this process, when a wide beam-width BW₁ is used for a beam of the moving backhaul hub (e.g., a transmission/reception beam of the moving backhaul hub), the moving backhaul terminal in a moving mode may take a long time to get out of the beam-width BW₁. On the other hand, when a narrow beam-width BW₃ is used, the moving backhaul terminal in the moving mode may take a short time to get out of the beam-width BW₃. Therefore, the time interval used by the moving backhaul terminal to transmit the location information may be configured as a different value (e.g., t^{BW}^{₃}≤t^{BW}^{₂}≤t^{BW}^{₁}) according to the beam-width (e.g., BW₁, BW₂, BW₃) currently used by the moving backhaul hub for transmission and reception.

The moving backhaul hub may perform a process of calculating, based on location information of the moving backhaul hub and/or the moving backhaul terminal, instantaneous values (e.g., d^{t}^{ₙ₊₁}, θₐ^{t}^{ₙ₊₁}, θₑ^{t}^{ₙ₊₁}) and cumulative values (e.g., Σ₀ⁿ⁺¹d^{t}^{ₙ₊₁}, Σ₀ⁿ⁺¹θₐ^{t}^{ₙ₊₁}, Σ₀ⁿ⁺¹θₑ^{t}^{ₙ₊₁}) for a separation distance between the moving backhaul hub and the moving backhaul terminal, an azimuth angle in which the beam of the moving backhaul hub should be directed, and an elevation angle in which the beam of the moving backhaul hub should be directed (S403). The above-described location information may be GPS information, and the above-described location information may include the latitude, longitude, and/or altitude information.

In this case, the moving backhaul hub may calculate the separation distance d between the moving backhaul hub and the moving backhaul terminal by using Equation 1 below (i.e., Pythagorean theorem) and Equation 2 below (i.e., Haversine formula) based on the location information (i.e., latitude, longitude and/or altitude) of the moving backhaul hub and/or the location information (i.e., latitude, longitude and/or altitude) of the moving backhaul terminal. In Equations 1 to 3 below, φ₁ may mean the latitude of the moving backhaul hub, λ₁ may mean the longitude of the moving backhaul hub, and h₁ may mean the altitude of the moving backhaul hub. Also, in Equation 1 above, φ₂ may mean the latitude of the moving backhaul terminal, λ₂ may mean the longitude of the moving backhaul terminal, and h₂ may mean the altitude of the moving backhaul terminal.

$$d = \sqrt{{Δφ}^{2} + Δ {λ}^{2}} = \sqrt{{Δφ}_{D M S}^{2} + Δ {λ}_{D M S}^{2}} \qquad [ Equation 1 ]$$

$${Δφ}_{D M S} = ( {D}_{φ} \times α ) + ( {M}_{φ} \times ( \frac{α}{60} ) ) + ( {S}_{φ} \times ( \frac{α}{60 \times 60} ) )$$

$$Δ {λ}_{D M S} = ( {D}_{λ} \times β ) + ( {M}_{λ} \times ( \frac{β}{60} ) ) + ( {S}_{λ} \times ( \frac{β}{60 \times 60} ) )$$

In Equation 1 above, Δφ may mean a latitude difference between the moving backhaul hub and the moving backhaul terminal (i.e., Δφ=φ₂=φ₁), and Δλ may be a longitude difference between the moving backhaul hub and the moving backhaul terminal (i.e., Δλ=λ₂−λ₁). In Equation 1, (D_{φ}, M_{φ}, S_{φ}) may mean a (Degree, Minutes, and Seconds (DMS)) conversion value for the latitude difference (Δφ=φ₂−φ₁) between the moving backhaul hub and the moving backhaul terminal. (D_{λ}, M_{λ}, S_{λ}) may mean a DMS conversion value for the longitude difference between the moving backhaul hub and the moving backhaul terminal (i.e., Δλ=λ₂−λ₁). In addition, α and β in Equation 1 may be defined as

$$α = ( \frac{2 π r}{360} ) and β = cos ( \frac{{φ}_{1} + {φ}_{2}}{2} ) \cdot α ,$$

respectively.

$$d = 2 \cdot r \cdot arcsin ( \sqrt{{sin}^{2} ( \frac{Δφ}{2} ) + cos ( {φ}_{1} ) cos ( {φ}_{2} ) {sin}^{2} ( \frac{Δ λ}{2} )} ) \qquad [ Equation 2 ]$$

In Equation 2 above, Δφ may mean the latitude difference between the moving backhaul hub and the moving backhaul terminal (i.e., Δφ=φ₂−φ₁), and Δλ may mean the longitude difference between the moving backhaul hub and the moving backhaul terminal (i.e., Δλ=λ₂−λ₁). In addition, in Equation 2 above, r may mean the radius of the earth. The moving backhaul hub may calculate the azimuth angle θₐ in which the beam of the moving backhaul hub should be directed by using Equation 3 below based on the location information (latitude, longitude and/or altitude) of the moving backhaul hub and/or the location information (latitude, longitude and/or altitude) of the moving backhaul terminal.

### Equation 3

θ_{α}=atan2(sin Δλ·cosφ₂, cosφ₁·sinφ₂−sinφ₁·cosφ₂·cosΔλ)

In Equation 3 above, Δφ may mean the latitude difference between the moving backhaul hub and the moving backhaul terminal (i.e., Δφ=φ₂−φ₁), and Δλ may mean the longitude difference between the moving backhaul hub and the moving backhaul terminal (i.e., Δλ=λ₂−λ₁). In addition, the moving backhaul may calculate the elevation angle θₑ in which the beam of the moving backhaul hub should be directed by using Equation 4 below based on the location information (latitude, longitude and/or altitude) of the moving backhaul hub and/or the location information (latitude, longitude and/or altitude) of the moving backhaul terminal.

$${θ}_{e} = tan ( \frac{Δ h}{d} ) \qquad [ Equation 4 ]$$

In Equation 4 above, Δh may mean an altitude difference between the moving backhaul hub and the moving backhaul terminal (i.e., Δh=h₂−h₁), and d may mean the separation distance between the moving backhaul hub and the moving backhaul terminal.

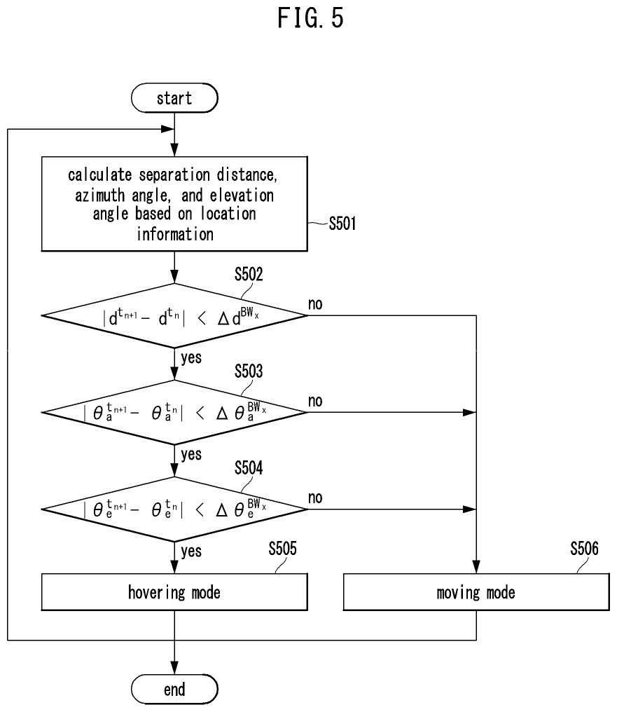

After the moving backhaul hub calculates the instantaneous values and/or the cumulative values for the separation distance between the moving backhaul hub and the moving backhaul terminal and the azimuth angle and the elevation angle to which the beam of the moving backhaul hub should be directed, the moving backhaul hub may determine an operation mode (i.e., hovering mode or moving mode) of the moving backhaul terminal by using the instantaneous values for each of the separation distance, the azimuth angle, and the elevation angle (S404). In this case, a procedure for the moving backhaul hub to determine the operation mode of the moving backhaul terminal may be the same as that described in FIG. 5 to be described later. In addition, after the moving backhaul hub determines the operation mode of the moving backhaul terminal, the moving backhaul hub may perform a process of respectively comparing the instantaneous values and/or cumulative values for each of the separation distance, azimuth angle, and elevation angle with allowable ranges of the separation distance, azimuth angle, and elevation angle (S405). That is, when the operation mode of the moving backhaul terminal is determined as the moving mode, the moving backhaul hub may compare differences (i.e., d^{t}^{ₙ₊₁}−d^{t}^{ₙ}, θₐ^{t}^{ₙ₊₁}−θₐ^{t}^{ₙ}, and θₑ^{t}^{ₙ₊₁}−θₑ^{t}^{ₙ}) of the instantaneous values for the separation difference, the azimuth angle, and the elevation angle with the allowable ranges (e.g., Δd^{BW}^{ₓ}, ∠θₐ^{BW}^{ₓ}, ∠θₑ^{BW}^{ₓ}), respectively. On the other hand, when the operation mode of the moving backhaul terminal is determined as the d tn heh±oivering mode, the moving backhaul hub may compare the cumulative values (i.e., Σ₀ⁿ⁺¹d^{t}^{ₙ₊₁}, Σ₀ⁿ⁺¹θₐ^{t}^{ₙ₊₁}, and Σ₀ⁿ⁺¹θₑ^{t}^{ₙ₊₁}) for the separation difference, the azimuth angle, and the elevation angle with the allowable ranges (e.g., Δd^{BW}^{ₓ}, ∠θₐ^{BW}^{ₓ}, ∠θₑ^{BW}^{ₓ}), respectively.

In the process of comparing the cumulative values or the instantaneous values with the allowable ranges (S405), if at least one of the instantaneous values for the separation distance, azimuth angle, and/or elevation angle exceeds the allowable range, the moving backhaul hub may transmit a beam search command message requesting beam search to the moving backhaul terminal (S406). After the moving backhaul hub transmits the beam search command message to the moving backhaul terminal, the moving backhaul hub may transmit beam signals according to a preconfigured beam search method around a traveling direction of the moving backhaul terminal (S407). Each beam signal may include identifier information (ID) (hereinafter referred to as beam ID) for each beam for smooth beam search.

The moving backhaul terminal receiving the beam search command message may measure (or search) each beam signal transmitted from the moving backhaul hub (S408). The moving backhaul terminal measuring each beam signal transmitted from the moving backhaul hub may transmit a beam search result message including measurement information for each beam signal to the moving backhaul hub (S409). The beam search result message may include a beam ID, and the measurement information for the beam signal may mean strength information of the beam signal measured as at least one of a signal-to-noise ratio (SNR), channel quality indicator (CQI), received signal strength indicator (RSSI), and reference signal received quality (RSRP), or reference signal received power (RSRP).

Upon receiving the beam search result message, the moving backhaul hub may select an optimal beam having the best signal strength (S410). In addition, when the existing beam to which the moving backhaul terminal belongs is not the same as the selected beam, the moving backhaul hub may initialize the cumulative values for the separation distance, azimuth angle, and/or elevation angle.

FIG. 5 is a flowchart illustrating a first exemplary embodiment of a procedure for determining an operation mode (hovering mode or moving mode) of a moving backhaul terminal performed in a moving backhaul hub.

Referring to FIG. 5, instantaneous values and/or cumulative values for each of the separation distance between the moving backhaul hub and the moving backhaul terminal, and the azimuth angle and elevation angle to which the beam of the moving backhaul hub should be directed may be calculated (S501). After calculating the instantaneous values and/or cumulative values, the moving backhaul hub may compare a difference between separation distances (e.g., d^{t}^{ₙ}, d^{t}^{ₙ₊₁}) obtained at a preset time interval (e.g., tₙ, tₙ₊₁) with the separation distance allowable range Δd^{BW}^{ₓ} (S502). When the difference between the separation distances (e.g., d^{t}^{ₙ}, d^{t}^{ₙ₊₁}) obtained at the preset time interval (e.g., tₙ, tₙ₊₁) is equal to or greater than the separation distance allowable range Δd^{BW}^{ₓ}, the moving backhaul hub may determine the operation mode of the moving backhaul termina as the moving mode (S506). When the difference between the separation distances (e.g., d^{t}^{ₙ}, d^{t}^{ₙ₊₁}) obtained at the preset time interval (e.g., tₙ, tₙ₊₁) is less than the separation distance allowable range Δd^{BW}^{ₓ}, the moving backhaul hub may compare a difference between azimuth angles (e.g., θₐ^{t}^{ₙ}, θₐ^{t}^{ₙ₊₁}) obtained at the preset time interval (e.g., tₙ, tₙ₊₁) with the azimuth angle allowable range ∠θₐ^{BW}^{ₓ} (S503). When the difference between the azimuth angles (e.g., θₐ^{t}^{ₙ}, θₐ^{t}^{ₙ₊₁}) obtained at the preset time interval (e.g., tₙ, tₙ₊₁) is equal to or greater than the azimuth angle allowable range ∠θₐ^{BW}^{ₓ}, the moving backhaul hub may determine the operation mode of the moving backhaul termina as the moving mode (S506). When the difference between the azimuth angles (e.g., θₐ^{t}^{ₙ}, θₐ^{t}^{ₙ₊₁}) obtained at the preset time interval (e.g., tₙ, tₙ₊₁) is less than the azimuth angle allowable range ∠θₐ^{BW}^{ₓ}, the moving backhaul hub may compare a difference between elevation angles (e.g., θₑ^{t}^{ₙ}, θₑ^{t}^{ₙ₊₁}) obtained at the preset time interval (e.g., tₙ, tₙ₊₁) with the elevation angle allowable range ∠θₑ^{BW}^{ₓ} (S504). When the difference between the elevation angles (e.g., θₑ^{t}^{ₙ}, θₑ^{t}^{ₙ₊₁}) obtained at the preset time interval (e.g., tₙ, tₙ₊₁) is equal to or greater than the elevation angle allowable range ∠θₑ^{BW}^{ₓ}, the moving backhaul hub may determine the operation mode of the moving backhaul termina as the moving mode (S506). When the difference between the elevation angles (e.g., θₑ^{t}^{ₙ}, θₑ^{t}^{ₙ₊₁}) obtained at the preset time interval (e.g., tₙ, tₙ₊₁) is less than the elevation angle allowable range ∠θₑ^{BW}^{ₓ}, the moving backhaul hub may determine the operation mode of the moving backhaul termina as the hovering mode (S506).

That is, the moving backhaul hub may perform the steps S502, S503, and S504 of respectively comparing the difference between the separation distances (d^{t}^{ₙ}, d^{t}^{ₙ₊₁}), the difference between the azimuth angles (θₐ^{t}^{ₙ}, θₐ^{t}^{ₙ₊₁}), and the difference between the elevation angles (θₑ^{t}^{ₙ}, θₑ^{t}^{ₙ₊₁}) which are obtained at the preset interval (tₙ, tₙ₊₁), with the allowable ranges Δd^{BW}^{ₓ}, ∠θₐ^{BW}^{ₓ}, and ∠θₑ^{BW}^{ₓ}. When all of the difference between the separation distances (d^{t}^{ₙ}, d^{t}^{ₙ₊₁}), the difference between the azimuth angles (θₐ^{t}^{ₙ}, θₐ^{t}^{ₙ₊₁}), and the difference between the elevation angles (θₑ^{t}^{ₙ}, θₑ^{t}^{ₙ₊₁}) satisfy the conditions according to the allowable ranges in the steps S502, S503, and S504, the moving backhaul hub may determine that the moving backhaul terminal is in the hovering mode (S505). On the other hand, when at least one of the difference between the separation distances (d^{t}^{ₙ}, d^{t}^{ₙ₊₁}), the difference between the azimuth angles (θₐ^{t}^{ₙ}, θₐ^{t}^{ₙ₊₁}) and the difference between the elevation angles (θₑ^{t}^{ₙ}, θₑ^{t}^{ₙ₊₁}) does not satisfy the conditions according to the allowable ranges in the steps S502, S503, and S504, the moving backhaul hub may determine the operation mode of the moving backhaul terminal as the moving mode (S506).

Here, the allowable range Δd^{BW}^{ₓ} for the difference between the separation distances (d^{t}^{ₙ}, d^{t}^{ₙ₊₁}) obtained at the preset time interval (tₙ, tₙ₊₁) may vary depending on the beam-width (BW₁, BW₂, or BW₃) used by the moving backhaul hub. For example, the allowable range for the difference between the separation distances may vary as Δd^{BW}^{₁}, Δd^{BW}^{₂}, or Δd^{BW}^{₃}.

In addition, the allowable range ∠θₐ^{BW}^{ₓ} for the difference between the azimuth angles (θₐ^{t}^{ₙ}, θₐ^{t}^{ₙ₊₁}) obtained at the preset time interval (tₙ, tₙ₊₁) may vary depending on the beam-width (BW₁, BW₂, or BW₃) used by the moving backhaul hub. For example, the allowable range for the difference between the azimuth angles may vary as ∠θₐ^{BW}^{₁}, ∠θₐ^{BW}^{₂}, or ∠θₐ^{BW}^{₃}. In addition, the allowable range ∠θₑ^{BW}^{ₓ} for the difference between the elevation angles (θₑ^{t}^{ₙ}, θₑ^{t}^{ₙ₊₁}) obtained at the preset time interval (tₙ, tₙ₊₁) may vary depending on the beam-width (BW₁, BW₂, or BW₃) used by the moving backhaul hub. For example, the allowable range for the difference between the elevation angles may vary as ∠θ^{BW}^{₁}, ∠θₑ^{BW}^{₂}, or ∠θₑ^{BW}^{₃}. The procedure (S501 to S506) for determining the operation mode (hovering mode or moving mode) of the moving backhaul terminal may be continuously performed by the moving backhaul hub while the radio link is configured between the moving backhaul hub and the moving backhaul terminal. Hereinafter, a beam search method performed in the moving backhaul system according to the operation mode of the moving backhaul terminal determined by the moving backhaul hub will be described.

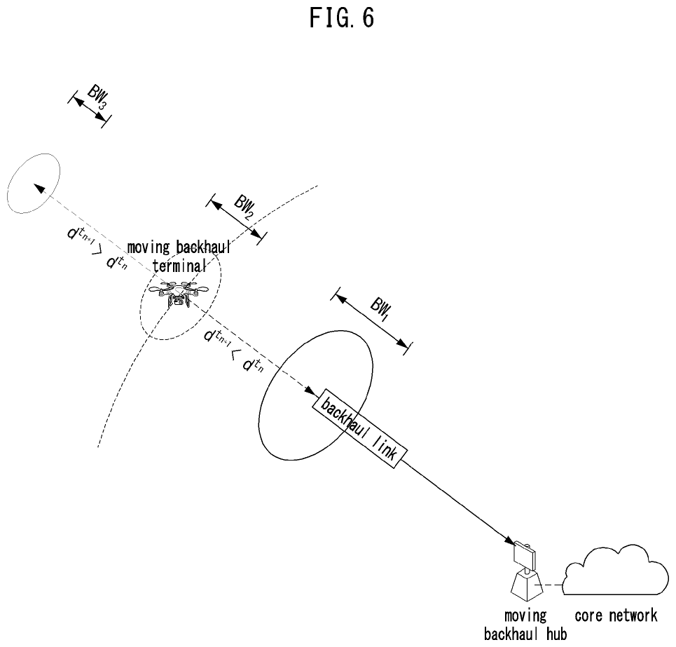

FIG. 6 is a conceptual diagram illustrating a first exemplary embodiment of a beam search method of a moving backhaul system when a moving backhaul terminal is in a moving mode (a case of change in separation distance).

Referring to FIG. 6 the operation mode of the moving backhaul terminal, which is determined by the moving backhaul hub, may be the moving mode. In this case, only the separation distance among the separation distance, azimuth angle, and elevation angle obtained using the location information of the moving backhaul hub and/or the moving backhaul terminal may deviate from the allowable range Δd^{BW}^{ₓ}. In this case, the moving backhaul hub may compare a signal strength B_{pow}^{BW}^{ₓ} of the beam, which is informed from the moving backhaul terminal, with an upper threshold value and/or lower threshold value (TH_{Ux}, TH_{Lx}) configured for each region Rₓ associated with the beam-width BWₓ. The moving backhaul hub may determine a beam-width of a beam to be used for re-searching of the moving backhaul terminal based on a result of the comparison.

Table 1 below shows conditions for changing the beam-width of the beam of the moving backhaul hub when the moving backhaul terminal is in the moving mode and only the separation distance among the separation distance, azimuth angle, and elevation angle obtained using the location information of the moving backhaul hub and/or the moving backhaul terminal deviates from the allowable range Δd^{BW}^{ₓ}.

TABLE 1

| Change in separation distance | Threshold comparison result | Whether to change a beam-width |
|---|---|---|
| \|d^{t}^{ₙ₊₁} − d^{t}^{ₙ}\| > Δd^{BW}^{ₓ}, | TH_{Lx} ≤ B_{pow}^{BW}^{ₓ} | Re-searching without changing the beam-width |
| (d^{t}^{ₙ₊₁} > d^{t}^{ₙ}) | B_{pow}^{BW}^{ₓ} < TH_{Lx} | Re-searching after changing to a narrower beam-width |
| \|d^{t}^{ₙ₊₁} − d^{t}^{ₙ}\| < Δd^{BW}^{ₓ}, | B_{pow}^{BW}^{ₓ} ≤ TH_{Ux} | Re-searching without changing the beam-width |
| (d^{t}^{ₙ₊₁} < d^{t}^{ₙ}) | TH_{Ux} < B_{pow}^{BW}^{ₓ} | Re-searching after changing to a wider beam-width |

When moving away from the moving backhaul hub according to the change in the separation distance between the moving backhaul hub and the moving backhaul terminal (i.e., d^{t}^{ₙ₊₁}>d^{t}^{ₙ}), the moving backhaul hub may compare the signal strength BpBowwx of the used beam with the lower threshold value TH_{Lx} of the beam region Rₓ associated with the beam-width of the beam. When the signal strength of the beam is smaller than the lower threshold value (i.e., B_{pow}^{BW}^{ₓ}<TH_{Lx}), the moving backhaul hub may change the beam to be used to a beam having a narrower beam-width (i.e., BWₓ→BWₓ₊₁). In addition, when the signal strength of the beam is smaller than the lower threshold value (i.e., B_{pow}^{BW}^{ₓ}<TH_{Lx}), the moving backhaul hub may use the beam having the changed beam-width to search for a beam to which the moving backhaul terminal belongs. On the other hand, when the signal strength of the beam is not less than the lower threshold value (i.e., TH_{Lx}≤B_{pow}^{BW}^{ₓ}), the moving backhaul hub may not change the beam to be used to a beam with a narrower beam-width, and the moving 10 backhaul hub may perform a process of searching for a beam to which the moving backhaul terminal belongs using the beam having the unchanged beam-width.

When moving closer to the moving backhaul hub according to the change in the separation distance between the moving backhaul hub and the moving backhaul terminal (i.e., d^{t}^{ₙ₊₁}<d^{t}^{ₙ}), the moving backhaul hub may compare the signal strength B_{pow}^{BW}^{ₓ} of the beam used with the upper threshold value TH_{Ux} corresponding to the beam region Rₓ associated with the beam-width of the beam. When the signal strength of the beam is greater than the above-described upper threshold value (i.e TH_{Ux}<B_{pow}^{BW}^{ₓ}) the moving backhaul hub may change the beam to be used to a beam having a wider beam-width (i.e., BWₓ→BWₓ₋₁), and the moving backhaul hub may perform a process of searching for a beam to which the moving backhaul terminal belongs. On the other hand, when the signal strength of the beam is not greater than the above-mentioned upper threshold value (i.e., B_{pow}^{BW}^{ₓ}≤TH_{Ux}), the moving backhaul hub may not change the beam-width of the beam used, and the moving backhaul hub may perform a process of searching for a beam to which the moving backhaul terminal belongs using the beam having the unchanged beam-width.

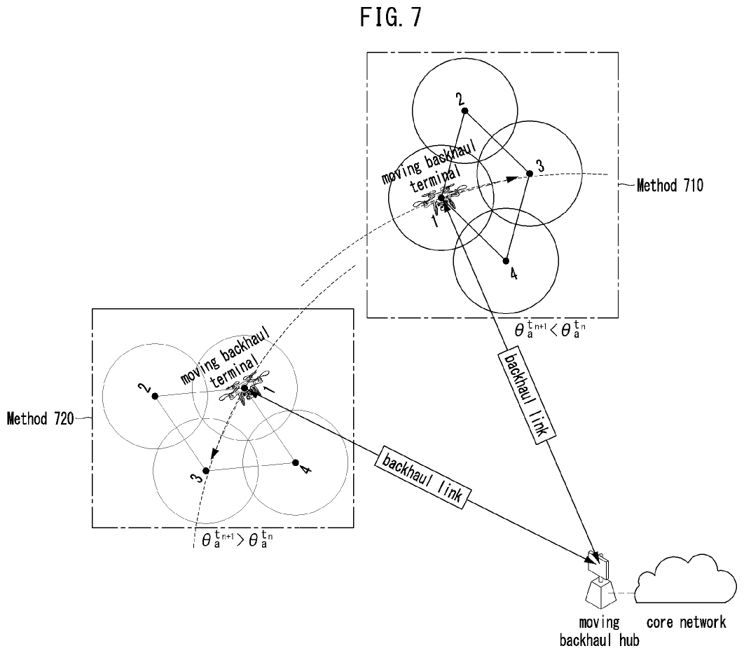

FIG. 7 is a conceptual diagram illustrating a first exemplary embodiment of a beam search method of a moving backhaul system when a moving backhaul terminal is in a moving mode (a case of change in azimuth angle).

Referring to FIG. 7, the operation mode of the moving backhaul terminal, which is determined by the moving backhaul hub, may be the moving mode. In this case, only the azimuth angle among the separation distance, azimuth angle, and elevation angle obtained using the location information of the moving backhaul hub and/or the moving backhaul terminal may deviate from the allowable range ∠θₐ^{BW}^{ₓ}. In this case, the moving backhaul hub may not change the beam-width of the beam used, and the moving backhaul hub may perform a process of searching for a beam to which the moving backhaul terminal belongs using the beam having the unchanged beam-width. For example, the moving backhaul hub may transmit beam signals to the moving backhaul terminal according to a preconfigured beam search method (i.e., B₁→B₂→B₃→B₄)

When the azimuth angle in which the beam of the moving backhaul hub should be directed decreases (i.e., θₐ^{t}^{ₙ₊₁}<θₐ^{t}^{ₙ}), the moving backhaul hub may transmit beam signals to the moving backhaul terminal according to a preconfigured first beam search method (i.e., B₁→B₂→B₃→B₄) (Method 710). For example, the first beam search method may be configured to search a beam in a direction in which the azimuth angle of the beam of the moving backhaul hub decreases. That is, the moving backhaul hub may not change the beam to be used to a beam having a narrower beam-width, and the moving backhaul hub may use the beam having the unchanged beam-width according to the first beam search method described above to search for a beam to which the moving backhaul terminal belongs. When the azimuth angle in which the beam of the moving backhaul hub should be directed increases (i.e., θₐ^{t}^{ₙ₊₁}>θₐ^{t}^{ₙ}), the moving backhaul hub may transmit beam signals to the moving backhaul terminal according to a preconfigured second beam search method (i.e., B₁→B₂→B₃→B₄) (Method 720). For example, the second beam search method may be configured to search a beam in a direction in which the azimuth angle of the beam of the moving backhaul hub increases. That is, the moving backhaul hub may not change the beam to be used to a beam having a narrower beam-width, and the moving backhaul hub may use the beam having the unchanged beam-width according to the second beam search method described above to search for a beam to which the moving backhaul terminal belongs.

For example, the moving backhaul hub may select a beam (e.g., B₁) having the largest signal strength from among the beam signals B₁, B₂, B₃, and B₄. Here, the moving backhaul hub may select a beam having the largest signal strength based on beam IDs included in the respective beam signals. The moving backhaul hub may use the selected beam B₁ as a new starting point in the beam re-search procedure performed in the moving mode (a case of change in azimuth angle). The moving backhaul hub may repeatedly perform the beam re-search procedure based on the selected beam, and this procedure may be applied identically (or similarly) to other exemplary embodiments below.

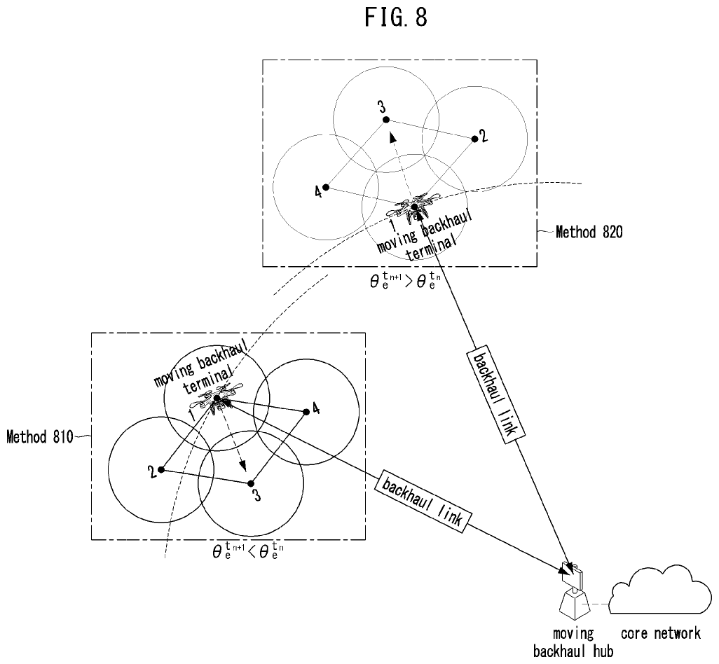

FIG. 8 is a conceptual diagram illustrating a first exemplary embodiment of a beam search method of a moving backhaul system when a moving backhaul terminal is in a moving mode (a case of change in elevation angle).

Referring to FIG. 8, the operation mode of the moving backhaul terminal, which is determined by the moving backhaul hub, may be the moving mode. In this case, only the elevation angle among the separation distance, azimuth angle, and elevation angle obtained using the location information of the moving backhaul hub and/or the moving backhaul terminal may deviate from the allowable range ∠θₑ^{BW}^{ₓ}. In this case, the moving backhaul hub may not change the beam-width of the beam used, and the moving backhaul hub may perform a process of searching for a beam to which the moving backhaul terminal belongs using the beam having the unchanged beam-width.

When the elevation angle in which the beam of the moving backhaul hub should be directed decreases (i.e., θₑ^{t}^{ₙ₊₁}<θₑ^{t}^{ₙ}), the moving backhaul may transmit beam signals to the moving backhaul terminal according to a preconfigured third search method (i.e., B₁→B₂→B₃→B₄) (Method 810). For example, the third beam search method may be configured to search a beam in a direction in which the elevation angle of the beam of the moving backhaul hub decreases. The moving backhaul hub may not change the beam to be used to a beam having a narrower beam-width, and the moving backhaul hub may use the beam having the unchanged beam-width according to the third beam search method described above to search for a beam to which the moving backhaul terminal belongs. When the elevation angle in which the beam of the moving backhaul hub should be directed increases (i.e., θₑ^{t}^{ₙ₊₁}>θₑ^{t}^{ₙ}), the moving backhaul hub may transmit beam signals to the moving backhaul terminal according to a preconfigured fourth beam search method (i.e., B₁→B₂→B₃→B₄) (Method 820). For example, the fourth beam search method may be configured to search a beam in a direction in which the elevation angle of the beam of the moving backhaul hub increases. The moving backhaul hub may not change the beam to be used to a beam having a narrower beam-width, and the moving backhaul hub may use the beam having the unchanged beam-width according to the fourth beam search method described above to search for a beam to which the moving backhaul terminal belongs.

The moving backhaul hub may select an optimal beam having the largest signal strength among the beam signals according to the preconfigured beam search method. For example, the moving backhaul hub may select a beam (e.g., B₁) having the largest signal strength from among the beam signals B₁, B₂, B₃, and B₄. Here, the moving backhaul hub may select a beam having the largest signal strength based on beam IDs included in the respective beam signals. The moving backhaul hub may use the selected beam B₁ as a new starting point in the beam re-search procedure performed in the moving mode (a case of change in elevation angle). The moving backhaul hub may repeatedly perform the beam re-search procedure based on the selected beam, and this procedure may be applied identically (or similarly) to other exemplary embodiments below.

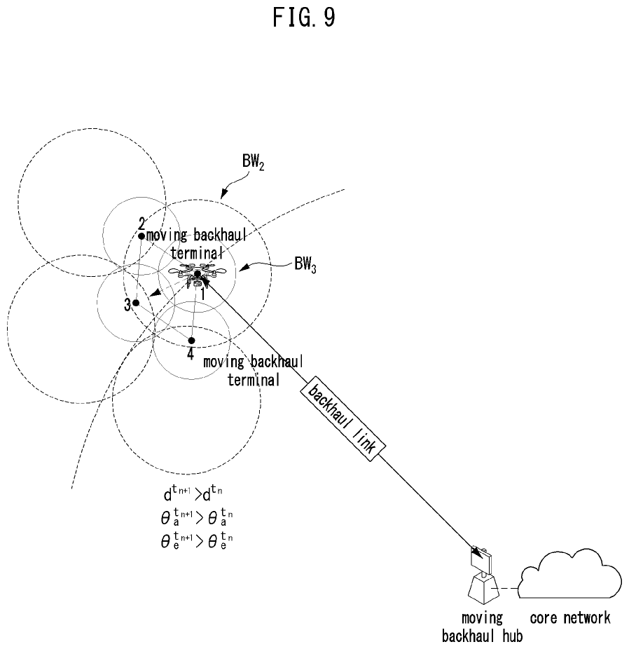

FIG. 9 is a conceptual diagram illustrating a first exemplary embodiment of a beam search method of a moving backhaul system when a moving backhaul terminal is in a moving mode (a case of change in separation distance, azimuth angle, and elevation angle).

Referring to FIG. 9, the operation mode of the moving backhaul terminal, which is determined by the moving backhaul hub, may be the moving mode. In this case, all of the separation distance, azimuth angle, and elevation angle obtained by using the location information of the moving backhaul hub and/or the moving backhaul terminal may deviate from the allowable ranges Δd^{BW}^{ₓ}, ∠θₐ^{BW}^{ₓ}, and ∠θₑ^{BW}^{ₓ}. In this case, when moving away from the moving backhaul hub according to the change in the separation distance between the moving backhaul hub and the moving backhaul terminal (i.e., d^{t}^{ₙ₊₁}>d^{t}^{ₙ}), the moving backhaul hub may compare the signal strength B_{pow}^{BW}^{ₓ} of the beam, which is informed from the moving backhaul terminal, with the lower threshold value TH_{Lx} configured for each region Rₓ associated with the beam-width BWₓ. The moving backhaul hub may determine a beam-width of a beam to be used for re-searching of the moving backhaul terminal.

When the signal strength of the beam is smaller than the lower threshold value (i.e., B_{pow}^{BW}^{ₓ}<TH_{Lx}), the moving backhaul hub may change the used beam to a beam having a narrower beam-width (i.e., BWₓ→BWₓ₊₁). In addition, when the signal strength of the beam is less than the lower threshold value (i.e., B_{pow}^{BW}^{ₓ}<TH_{Lx}) the moving backhaul hub may use the beam with the changed beam-width (e.g., BW₃) to perform a process of searching for a beam to which the moving backhaul terminal belongs. On the other hand, when the signal strength of the beam is not less than the lower threshold value (i.e., TH_{Lx}≤B_{pow}^{BW}^{ₓ}) the moving backhaul hub may not change the beam to be used to a beam with a narrower beam-width, and the moving backhaul hub may perform a process of searching for a beam to which the moving backhaul terminal belongs using the beam having the unchanged beam-width (e.g., BW₂).

The moving backhaul hub may select a beam having the largest signal strength among beam signals received from the moving backhaul terminal. For example, the moving backhaul hub may transmit beam signals to the moving backhaul terminal according to a preconfigured fifth beam search method (i.e., B₁→B₂→B₃→B₄), and the moving backhaul hub may select a beam (e.g., B₁) having the largest signal strength among the beam signals B₁, B₂, B₃, and B₄. Here, the moving backhaul hub may select a beam having the largest signal strength based on beam IDs included in the respective beam signals. The moving backhaul hub may use the selected beam B₁ as a new starting point in the beam re-search procedure performed according to the moving mode (a case of change in separation distance, azimuth angle, and elevation angle). The moving backhaul hub may repeatedly perform the beam re-search procedure based on the selected beam, and this procedure may be applied identically (or similarly) to other exemplary embodiments below.

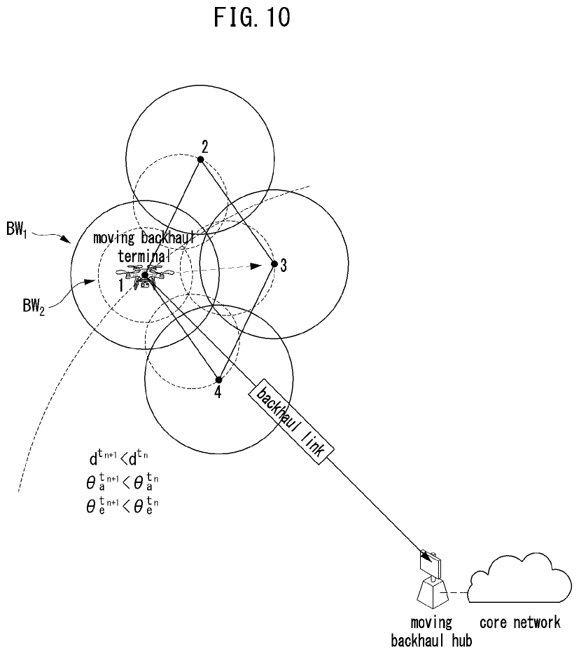

FIG. 10 is a conceptual diagram illustrating a second exemplary embodiment of a beam search method of a moving backhaul system when a moving backhaul terminal is in a moving mode (a case of change in separation distance, azimuth angle, and elevation angle).

Referring to FIG. 10, the operation mode of the moving backhaul terminal, which is determined by the moving backhaul hub, may be the moving mode. In this case, all of the separation distance, azimuth angle, and elevation angle obtained by using the location information of the moving backhaul hub and/or the moving backhaul terminal may deviate from the allowable ranges Δd^{BW}^{ₓ}, ∠θₐ^{BW}^{ₓ}, and ∠θₑ^{BW}^{ₓ}. When the moving hub terminal moves closer to the moving backhaul hub according to the change in the separation distance between the moving backhaul hub and the moving backhaul terminal (i.e., d^{t}^{ₙ₊₁}<d^{t}^{ₙ}), the moving backhaul hub may compare the signal strength B_{pow}^{BW}^{ₓ} of the beam, which is informed from the moving backhaul terminal, with the upper threshold value TH_{Ux} configured for each region Rₓ associated with the beam-width BWₓ. The moving backhaul hub may determine a beam-width of a beam to be used for re-searching of the moving backhaul terminal based on a result of the above comparison.

The moving backhaul hub may compare the signal strength B_{pow}^{BW}ₓ of the beam to be used with the upper threshold value TH_{Ux} of the beam region Rₓ associated with the beam-width of the aforementioned beam. When the signal strength of the beam is greater than the upper threshold value (i.e., B_{pow}^{BW}^{ₓ}>TH_{Ux}), the moving backhaul hub may change the beam to be used to a beam having a wider beam-width (i.e., BWₓ→BWₓ₋₁). In addition, when the signal strength of the beam is greater than the upper threshold (i.e., B_{pow}^{BW}ₓ>TH_{Ux}), the moving backhaul hub may use the beam having the changed beam-width (e.g., BW₁) to perform a process of searching for a beam to which the terminal belongs (shown by solid lines). On the other hand, when the signal strength of the beam is not greater than the upper threshold value (i.e., B_{pow}^{BW}^{ₓ}≤TH_{Ux}), the moving backhaul hub may not change the used beam to a beam having a wider beam-width, and the moving backhaul hub may perform a process of searching for a beam to which the moving backhaul terminal belongs using the beam having the unchanged beam-width (e.g., BW₂) (shown by dotted lines).

The moving backhaul hub may select a beam having the largest signal strength among beam signals according to a preconfigured beam search method. For example, the moving backhaul hub may transmit beam signals to the moving backhaul terminal according to a preconfigured sixth beam search method (i.e., B₁→B₂→B₃→B₄), and the moving backhaul hub may select a beam (e.g., B₁) having the largest signal strength among the beam signals B₁, B₂, B₃, and B₄. Here, the moving backhaul hub may select a beam having the largest signal strength based on beam IDs included in the respective beam signals. The moving backhaul hub may use the selected beam B₁ as a new starting point in the beam re-search procedure performed according to the moving mode (a case of change in separation distance, azimuth angle, and elevation angle). The moving backhaul hub may repeatedly perform the beam re-search procedure based on the selected beam, and this procedure may be applied identically (or similarly) to other exemplary embodiments below.

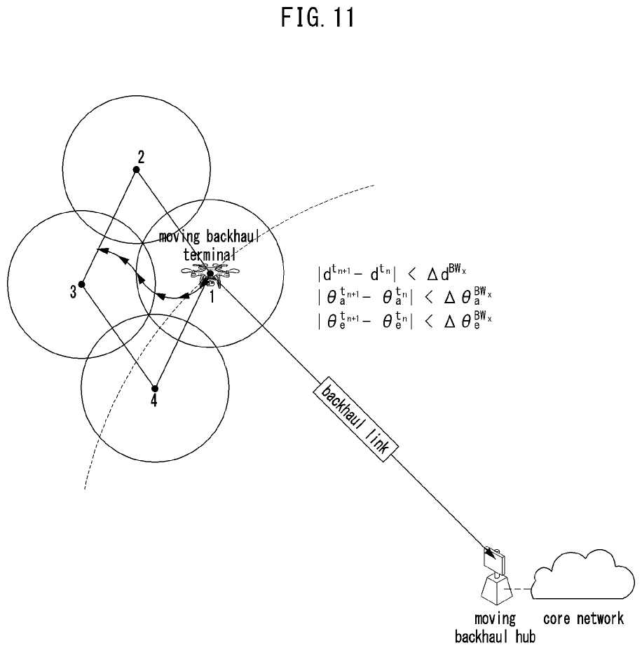

FIG. 11 is a conceptual diagram illustrating a first exemplary embodiment of a beam search method of a moving backhaul system when a moving backhaul terminal is in a hovering mode.

Referring to FIG. 11, the operation mode of the moving backhaul terminal, which is determined by the moving backhaul hub, may be the hovering mode. The instantaneous values for the separation distance, azimuth angle and/or elevation angle obtained at a preset time interval (e.g., tₙ, tₙ₊₁) may be within the allowable ranges Δd^{BW}^{ₓ}, ∠θₐ^{BW}^{ₓ}, and ∠θₑ^{BW}^{ₓ}, respectively. However, the cumulative values (e.g., |Σᵢ₌₀ⁿ⁺¹d^{t}^{ᵢ}|, |Σᵢ₌₀ⁿ⁺¹θₐ^{t}^{ᵢ}|, and |Σᵢ₌₀ⁿ⁺¹θₑ^{t}^{ᵢ}|) for the separation distance, azimuth angle and/or elevation angle, which are accumulated from the time t₀, at which the hovering mode started, to the most recent time tₙ₊₁, at which the moving backhaul terminal maintains the hovering mode, may be out of the allowable ranges. For example, even if each of the instantaneous values for the separation distance, azimuth angle and/or elevation angle falls within the allowable range, the cumulative values for the separation distance, azimuth angle and/or elevation angle may be out of the allowable ranges due to external factors such as a GPS error.

In this case, the moving backhaul hub may determine a beam search method by comparing the cumulative values for the separation distance, azimuth angle, and/or elevation angle, which are accumulated in the hovering mode, with the respective allowable ranges. That is, when the moving backhaul hub determines that at least one of the cumulative values for the separation distance, azimuth angle and/or elevation angle is out of the allowable range as a result of the comparison, the moving backhaul hub may perform a beam search method among the beam search methods (described in FIGS. 6 to 10) even in the hovering mode identically or similarly to the moving mode.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A beam management method performed by a moving backhaul hub in a moving backhaul system, the beam management method comprising:
calculating, based on location information at a first time, a first separation distance between the moving backhaul hub and a moving backhaul terminal, a first azimuth angle to which a beam of the moving backhaul hub is directed, and a first elevation angle in which the beam of the moving backhaul hub is directed;
determining an operation mode of the moving backhaul terminal using the first separation distance, the first azimuth angle, and/or the first elevation angle;
determining whether to transmit a beam search command message to the moving backhaul terminal based on the operation mode of the moving backhaul terminal; and
transmitting signals to the moving backhaul terminal in consideration of the operation mode when the beam search command message is transmitted to the moving backhaul terminal.

2. The beam management method according to claim 1, wherein the determining of the operation mode comprises:
calculating a second separation distance between the moving backhaul hub and the moving backhaul terminal based on location information at a second time; and
determining the operation mode of the moving backhaul terminal as a moving mode when a difference between the first separation distance and the second separation distance is equal to or greater than a first predetermined value.

3. The beam management method according to claim 1, wherein the determining of the operation mode comprises:
calculating a second azimuth angle to which the beam of the moving backhaul hub is directed based on location information at a second time; and
determining the operation mode of the moving backhaul terminal as a moving mode when a difference between the first azimuth angle and the second azimuth angle is equal to or greater than a second predetermined value.

4. The beam management method according to claim 1, wherein the determining of the operation mode comprises:
calculating a second elevation angle to which the beam of the moving backhaul hub is directed based on location information at a second time; and
determining the operation mode of the moving backhaul terminal as a moving mode when a difference between the first elevation angle and the second elevation angle is equal to or greater than a third predetermined value.

5. The beam management method according to claim 1, wherein the determining of the operation mode comprises:
calculating, based on location information at a second time, a second separation distance between the moving backhaul hub and the moving backhaul terminal, a second azimuth angle to which the beam of the moving backhaul hub is directed, and a second elevation angle to which the beam of the moving backhaul hub is directed; and
determining the operation mode of the moving backhaul terminal as a hovering mode when a difference between the first separation distance and the second separation distance is less than a first predetermined value, a difference between the first azimuth angle and the second azimuth angle is less than a second predetermined value, and a difference between the first elevation angle and the second elevation angle is less than a third predetermined value.

6. The beam management method according to claim 1, wherein in the determining of whether to transmit the beam search command message, when the operation mode of the moving backhaul terminal is determined as a moving mode and a difference of instantaneous values of the first separation distance between the moving backhaul hub and the moving backhaul terminal is equal to or greater than a first predetermined value, the moving backhaul hub determines to transmit the beam search command message to the moving backhaul terminal.

7. The beam management method according to claim 1, wherein in the determining of whether to transmit the beam search command message, when the operation mode of the moving backhaul terminal is determined as a moving mode and a difference of instantaneous values of the first azimuth angle is equal to or greater than a second predetermined value, the moving backhaul hub determines to transmit the beam search command message to the moving backhaul terminal.

8. The beam management method according to claim 1, wherein in the determining of whether to transmit the beam search command message, when the operation mode of the moving backhaul terminal is determined as a moving mode and a difference of instantaneous values of the first elevation angle is equal to or greater than a third predetermined value, the moving backhaul hub determines to transmit the beam search command message to the moving backhaul terminal.

9. The beam management method according to claim 1, wherein in the determining of whether to transmit the beam search command message, when the operation mode of the moving backhaul terminal is determined as a hovering mode and a cumulative value of the first separation distance between the moving backhaul hub and the moving backhaul terminal is equal to or greater than a first predetermined value, the moving backhaul hub determines to transmit the beam search command message to the moving backhaul terminal.

10. The beam management method according to claim 1, wherein in the determining of whether to transmit the beam search command message, when the operation mode of the moving backhaul terminal is determined as a hovering mode and a cumulative value of the first azimuth angle is equal to or greater than a second predetermined value, the moving backhaul hub determines to transmit the beam search command message to the moving backhaul terminal.

11. The beam management method according to claim 1, wherein in the determining of whether to transmit the beam search command message, when the operation mode of the moving backhaul terminal is determined as a hovering mode and a cumulative value of the first elevation angle is equal to or greater than a third predetermined value, the moving backhaul hub determines to transmit the beam search command message to the moving backhaul terminal.

12. The beam management method according to claim 1, further comprising:
receiving, from the moving backhaul terminal, a beam search result message including measurement result information on the signals; and
selecting a first beam having a largest signal strength based on the measurement result information of the signals.

13. A moving backhaul hub in a moving backhaul system, comprising:
a processor;
a memory electronically communicating with the processor; and
instructions stored in the memory,
wherein when executed by the processor, the instructions cause the moving backhaul hub to perform:
calculating, based on location information at a first time, a first separation distance between the moving backhaul hub and a moving backhaul terminal, a first azimuth angle to which a beam of the moving backhaul hub is directed, and a first elevation angle in which the beam of the moving backhaul hub is directed;
determining an operation mode of the moving backhaul terminal using the first separation distance, the first azimuth angle, and/or the first elevation angle;
determining whether to transmit a beam search command message to the moving backhaul terminal based on the operation mode of the moving backhaul terminal; and
transmitting signals to the moving backhaul terminal in consideration of the operation mode when the beam search command message is transmitted to the moving backhaul terminal.

14. The moving backhaul hub according to claim 13, wherein in the determining of the operation mode, the instructions further cause the moving backhaul hub to perform:
calculating a second separation distance between the moving backhaul hub and the moving backhaul terminal based on location information at a second time; and
determining the operation mode of the moving backhaul terminal as a moving mode when a difference between the first separation distance and the second separation distance is equal to or greater than a first predetermined value.

15. The moving backhaul hub according to claim 13, wherein in the determining of the operation mode, the instructions further cause the moving backhaul hub to perform:
calculating a second azimuth angle to which the beam of the moving backhaul hub is directed based on location information at a second time; and
determining the operation mode of the moving backhaul terminal as a moving mode when a difference between the first azimuth angle and the second azimuth angle is equal to or greater than a second predetermined value.

16. The moving backhaul hub according to claim 13, wherein in the determining of the operation mode, the instructions further cause the moving backhaul hub to perform:
calculating a second elevation angle to which the beam of the moving backhaul hub is directed based on location information at a second time; and
determining the operation mode of the moving backhaul terminal as a moving mode when a difference between the first elevation angle and the second elevation angle is equal to or greater than a third predetermined value.
